(19) United States
(12) Patent Application Publication
(10) Pub. No.: US 2023/0139655 A1
(43) Pub. Date: May 4, 2023

(54) METHOD AND DEVICE FOR BEAM FAILURE RECOVERY, USER EQUIPMENT

(71) Applicant: GUANGDONG OPPO MOBILE TELECOMMUNICATIONS CORP., LTD., Dongguan (CN)

(72) Inventor: LI GUO, Allen, TX (US)

(21) Appl. No.: 18/146,035

(22) Filed: Dec. 23, 2022

Related U.S. Application Data
(63) Continuation of application No. PCT/CN2021/109245, filed on Jul. 29, 2021.
(60) Provisional application No. 63/081,006, filed on Sep. 21, 2020.

(51) Int. Cl. H04W 76/19; H04W 24/08; H04W 24/10; H04W 74/08

(52) U.S. Cl. CPC H04W 76/19; H04W 24/08; H04W 24/10; H04W 74/0841; H04W 80/04

(57) ABSTRACT

A method and device for beam failure recovery, and a UE are provided. The method includes: obtaining, by a UE, a first set of beam failure detection reference signals (RSs) and a second set of beam failure detection RSs, the first set of beam failure detection RSs being a source of quasi-co-location (QCL) assumption for a PDCCH associated with a first TRP and the second set of beam failure detection RSs being a source of QCL assumption for a PDCCH associated with a second TRP; and performing, by the UE, beam failure detection and beam failure recovery for the first TRP according to the first set of beam failure detection RSs and performing beam failure detection and beam failure recovery for the second TRP according to the second set of beam failure detection RSs.

### CROSS-REFERENCE TO RELATED APPLICATIONS

This disclosure is filed based upon and claims priority to U.S. Provisional Application No. 63/081,006, entitled “Methods and Apparatuses for per-TRP Beam Failure Recovery”, filed on Sep. 21, 2020, the entire contents of which are incorporated herein by reference in its entirety.

### TECHNICAL FIELD

The present disclosure relates to the field of mobile communication, and particularly to a method and device for beam failure recovery (BFR), and a user equipment (UE).

### BACKGROUND

BFR functions specified in the current 3rd Generation Partnership Project (3GPP) specification only works for a single transmission/reception point (TRP) case. In a multi-TRP system, a UE may receive a physical downlink control channel (PDCCH) from two TRPs. If the current BFR method is just applied in the multi-TRP system, the UE may declare beam failure only when all the control resource sets (CORESETs) from both TRPs fail the beam and thus the UE reports the beam failure of one cell only when all the PDCCHs of both TRPs meet beam failure. But, in general real-field deployment, different TRPs are located in different physical locations. Thus, it is expected that the beam failure of PDCCH of two TRPs may happen independently. For instance, when a first TRP experiences beam failure due to blockage, a second TRP does not have beam failure. If the current design of BFR is applied, the UE may not report the beam failure to the network (NW) and thus the beam failure on the first TRP is not recovered. In a New Radio (NR) system, two services, i.e., Ultra-Reliable Low Latency Communication (URLLC) and Enhanced Mobile Broadband (eMBB), are introduced. URLLC has a characteristic of implementing ultra-reliable (for example, 99.999%) transmission in an extremely low latency (for example, 1 ms), and eMBB has a characteristic of insensitivity to a latency but support of a large number of transmissions. In a scenario where URLLC and eMBB coexist, for implementing real-time transmission of URLLC, when URLLC and eMBB transmissions conflict, URLLC and eMBB may interfere with each other, which influences demodulation performance of URLLC. Retransmission may reduce the influences but may prolong a transmission latency of URLLC.

### SUMMARY

Embodiments of the disclosure provide a method and device for beam failure recovery, a UE, a chip, a computer-readable storage medium, a computer program product and a computer program.

A first aspect of the disclosure provides a method for beam failure recovery, which may include the following operations.

A UE obtains a first set of beam failure detection reference signals (RSs) and a second set of beam failure detection RSs. The first set of beam failure detection RSs is a source of quasi-co-location (QCL) assumption for a PDCCH associated with a first TRP, and the second set of beam failure detection RSs is a source of QCL assumption for a PDCCH associated with a second TRP.

The UE performs beam failure detection and beam failure recovery for the first TRP according to the first set of beam failure detection RSs and performs beam failure detection and beam failure recovery for the second TRP according to the second set of beam failure detection RSs.

A second aspect of the disclosure provides a device for failure recovery, which may be applied to a UE. The device may include an obtaining unit and a processing unit.

The obtaining unit is configured to obtain a first set of beam failure detection RSs and a second set of beam failure detection RSs. The first set of beam failure detection RSs is a source of QCL assumption for a PDCCH associated with a first TRP, and the second set of beam failure detection RSs is a source of QCL assumption for a PDCCH associated with a second TRP.

The processing unit is configured to perform beam failure detection and beam failure recovery for the first TRP according to the first set of beam failure detection RSs and perform beam failure detection and beam failure recovery for the second TRP according to the second set of beam failure detection RSs.

A third aspect of the disclosure provides a UE, which may include a processor and a memory. The memory may be configured to store a computer program. The processor may be configured to call and run the computer program stored in the memory to execute the method in the first aspect or each implementation mode thereof.

A fourth aspect of the disclosure provides a chip, which may be configured to implement the method in the first aspect or each implementation mode thereof. Specifically, the chip may include a processor, configured to call and run a computer program in a memory to enable a device installed with the chip to execute the method in the first aspect or each implementation mode thereof.

A fifth aspect of the disclosure provides a computer-readable storage medium, which may be configured to store a computer program. The computer program enables a computer to execute the method in the first aspect or each implementation mode thereof.

A sixth aspect of the disclosure provides a computer program product, which may include a computer program instruction. The computer program instruction enables a computer to execute the method in the first aspect or each implementation mode thereof.

A seventh aspect of the disclosure provides a computer program. The computer program may run in a computer to enable the computer to execute the method in the first aspect or each implementation mode thereof.

Through the above technical solutions, the first TRP and the second TRP may perform respective beam failure detection independently, such that beam failure recovery for the first TRP may be performed when beam failure of the first TRP is detected, and beam failure recovery for the second TRP may be performed when beam failure of the second TRP is detected, thereby improving the efficiency of beam failure recovery.

### BRIEF DESCRIPTION OF THE DRAWINGS

The drawings described herein are used to provide a further understanding of the disclosure and form a part of the disclosure. The schematic embodiments of the disclosure and the description thereof are used to explain the disclosure and do not constitute an improper limitation of the disclosure. In the drawings:

FIG. 1 is a schematic diagram of an applicant scenario according to an embodiment of the disclosure.

FIG. 2A is a schematic diagram of multi-TRP based joint transmission.

FIG. 2B is another schematic diagram of multi-TRP based joint transmission.

FIG. 3 is a schematic flowchart of a method for beam failure recovery according to an embodiment of the disclosure t.

FIG. 4 is a first schematic diagram of a Media Access Control Control Element (MAC CE) according to an embodiment of the disclosure.

FIG. 5 is a second schematic diagram of a MAC CE according to an embodiment of the disclosure.

FIG. 6 is a schematic structure diagram of a device for beam failure recovery according to an embodiment of the disclosure.

FIG. 7 is a schematic structure diagram of a communication device according to an embodiment of the disclosure.

FIG. 8 is a schematic structure diagram of a chip according to an embodiment of the disclosure.

FIG. 9 is a schematic diagram of a communication system according to an embodiment of the disclosure.

### DETAILED DESCRIPTION

The technical solutions in the embodiments of the disclosure will be described below in combination with the drawings in the embodiments of the disclosure. It is apparent that the described embodiments are not all embodiments but part of embodiments of the disclosure. All other embodiments obtained by those of ordinary skill in the art based on the embodiments in the disclosure without creative work shall fall within the scope of protection of the disclosure.

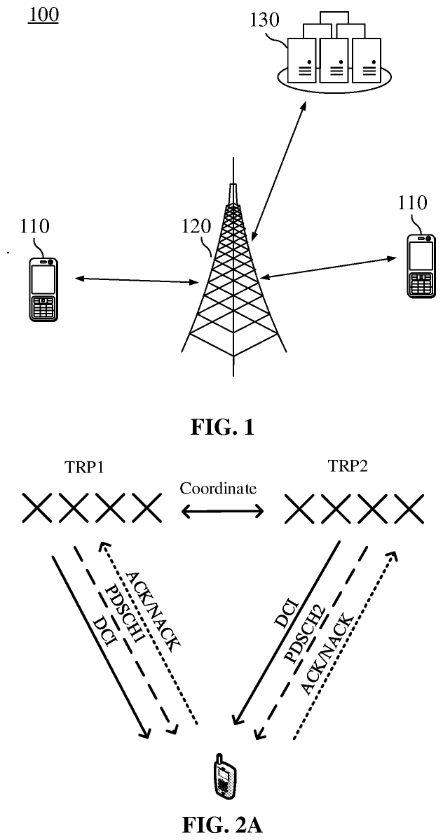

FIG. 1 is a schematic diagram of an applicant scenario according to an embodiment of the disclosure.

As illustrated in FIG. 1, the communication system 100 may include a UE 110 and a network device 120. The network device 120 may communicate with the UE 110 through an air interface. The UE 110 and the network device support multi-service transmission.

The embodiments of the disclosure are described by taking the communication system 100 as an example, which is not limited to the embodiments of the disclosure. The technical solutions of the embodiments of the disclosure may be applied to various communication systems, for example, a Long Term Evolution (LTE) system, LTE Time Division Duplex (TDD), a Universal Mobile Telecommunication System (UMTS), an Internet of Things (IoT) system, a Narrow Band IoT (NB-IoT) system, an enhanced Machine-Type Communications (eMTC) system, a 5^{th} Generation communication (5G) system (which refers to a New Radio (NR) communication system), a future communication system or the like.

In the communication system 100 illustrated in FIG. 1, the network device 120 may be an access network device communicated with the UE 110. The access network device may provide communication coverage for a specific geographical region and communicate with the UE 110 located in the coverage. The network device 120 may be an Evolutional Node B (eNB or eNodeB) in the LTE system, a Next Generation Radio Access Network (NG RAN) device, a next generation NodeB (gNB) in the NR system, or a wireless controller in a Cloud Radio Access Network (CRAN). Alternatively, the network device may be a relay station, an access point, a vehicle-mounted device, a wearable device, a hub, a switch, a network bridge, a router, a network device in a future evolved Public Land Mobile Network (PLMN) or the like.

The UE 110 may be any UE, and includes, but is not limited to, a UE connected to the network device 120 or another UE via a wired or wireless connection. The UE 110 may be referred to an access terminal, a User Equipment (UE), a subscriber unit, a subscriber station, a mobile station, a mobile radio station, a remote station, a remote terminal, a mobile device, a user terminal, a terminal, a wireless communication device, a user agent or a user device. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device with a wireless communication function, a computing device or other processing device connected to a wireless modem, a vehicle-mounted device, a wearable device, a UE in a 5G network, a UE in a future evolved PLMN or the like.

The UE 110 may be used for Device to Device (D2D) communication.

The wireless communication system 100 may also include a core network device 130 that communicates with the base station. The core network device 130 may be a 5G Core (5GC) device, for example, an Access and Mobility Management Function (AMF), an Authentication Server Function (Authentication Server Function (AUSF), a User Plane Function (UPF), and for another example, a Session Management Function (SMF). In one example, the core network device 130 may also be an Evolved Packet Core (EPC) device in the LTE network, for example, a Session Management Function+Core Packet Gateway (SMF+PGW-C) device. It should be understood that SMF+PGW-C may simultaneously achieves the functions that SMF and PGW-C may perform. During the evolution of the network, the core network device may also be called other names or form a new network entity by dividing the functions of the core network, which is not limited by the embodiments of this application.

The various functional units in the communication system 100 may also communicate with each other by establishing connections via the next generation network (NG) interface.

For example, the UE establishes an air interface connection with the access network device via the NR interface for transmission of user-plane data and control-plane signaling. The UE may establish a control-plane signaling connection to the AMF via a NG interface 1 (N1). The access network device, such as a gNB, may establish a user-plane data connection to the UPF via a NG interface 3 (N3). The access network device may establish a control-plane signaling connection to the AMF via a NG interface 2 (N2). The UPF may establish a control-plane signaling connection to the SMF via a NG interface 4 (N4). The UPF may interact with the data network for user-plane data via a NG interface 6 (N6). The AMF may establish a control-plane signaling connection to the SMF via a NG interface 11 (N11). The SMF may establish a control plane signaling connection with the PCF via a NG interface 7 (N7).

FIG. 1 exemplarily illustrates one base station, one core network device and two UE. In one example, the communication system 100 may include multiple base stations, and another number of UE may be included in coverage of each base station. No limits are made thereto in the embodiments of the disclosure.

FIG. 1 merely exemplarily illustrates the system to which the present disclosure is applied, but the method in the embodiments of the disclosure may also be applied to other systems. Terms “system” and “network” in the disclosure may usually be interchanged in the disclosure. In the disclosure, the term “and/or” is only an association relationship describing associated objects and represents that three relationships may exist. For example, A and/or B may represent three conditions: i.e., independent existence of A, existence of both A and B, and independent existence of B. In addition, character “/” in the disclosure usually represents that previous and next associated objects form an “or” relationship. It is also to be understood that the term “indication” in embodiments of the present disclosure may be a direct indication, an indirect indication, or an indication of an associative relationship. For example, an indication of B by A may indicate that A directly indicates B, for example, B is obtained through A, or that A indirectly indicates B, for example, A indicates C and B is obtained through C, or that there is an association between A and B. It is also to be understood that the term “correspondence” in embodiments of the present disclosure may indicate a direct or indirect correspondence between the two elements, or may indicate an association between the two elements, or may indicate a relationship of indicating and being indicated, configuring and being configured, etc. It is also to be understood that the term “predefined” or “predefined rules” in embodiments of the present disclosure may be achieved by pre-storing corresponding codes, tables or other manners for indicating relevant information in devices (e.g., including a UE and a network device). The specific implementation is not limited in the present disclosure. For example, “predefined” may refer to those defined in a protocol. It is also to be understood that in this disclosure, “protocol” may refer to a standard protocol in the field of communication, which may include, for example, a LTE protocol, NR protocol and relevant protocol applied in the future communication system, which is not limited in the present disclosure.

To make the technical solutions of the embodiments of the disclosure to be understood better, the relevant technology of the embodiments of the disclosure is described below. The following relevant technology as optional solutions may be combined with the technical solutions of the embodiments in any way, and shall fall within the scope of protection of the disclosure.

The NR system introduces multi-TRP based non-coherent joint transmission. Multiple TRPs are connected through a backhaul link for coordination. The backhaul link may be ideal or non-ideal. In the case of ideal backhaul, the TRPs may exchange dynamic PDSCH scheduling information with short latency and thus the different TRPs may coordinate the PDSCH transmission per PDSCH transmission. While, in non-ideal backhaul case, the information exchange between TRPs has large latency and thus the coordination between TRPs may only be semi-static or static.

In the non-coherent joint transmission, different TRPs use different PDCCHs to schedule the PDSCH transmission independently. Each TRP may send one DCI to schedule one physical downlink shared channel (PDSCH) transmission. PDSCHs from different TRPs may be scheduled in same or different slots. Two different PDSCH transmissions from different TRPs may be fully overlapped or partially overlapped in PDSCH resource allocation. To support the multi-TRP based non-coherent joint transmission, a UE is requested to receive PDCCH from multiple TRPs and then receive PDSCH sent from multiple TRPs. For each PDSCH transmission, the UE may feedback Hybrid Automatic Repeat reQuest-Acknowledgement (HARQ-ACK) information to the network. In the multi-TRP transmission, the UE may feedback the HARQ-ACK information for each PDSCH transmission to the TRP transmitting the PDSCH. The UE may also feedback the HARQ-ACK information for a PDSCH transmission sent from any TRP to one particular TRP.

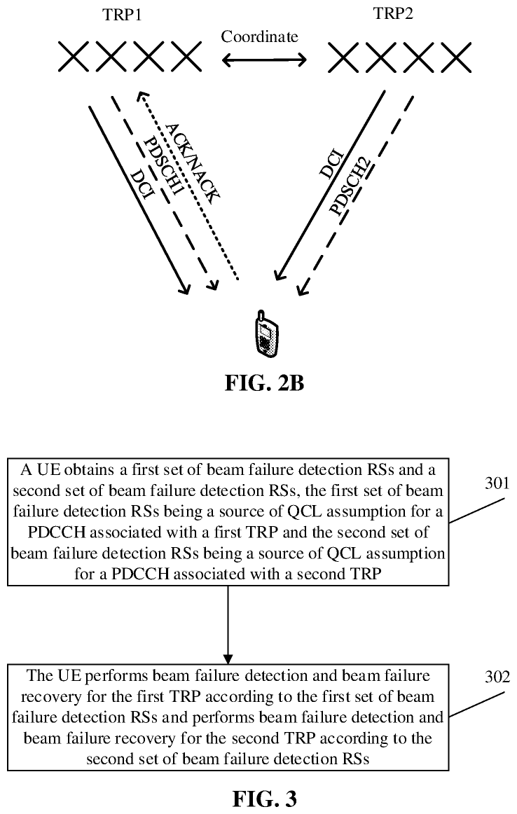

An example of multi-TRP based non-coherent joint transmission is illustrated in FIG. 2A. A UE receives PDSCH based on non-coherent joint transmission from two TRPs: TRP1 and TRP2. As illustrated in FIG. 2A, the TRP1 sends one DCI to schedule the transmission of PDSCH1 to the UE and the TRP2 sends one DCI to schedule the transmission of PDSCH 2 to the UE. At the UE side, the UE receives and decodes the DCI from both TRPs. Based on the DCI from TRP1, the UE receives and decodes PDSCH1 and based on the DCI from TRP2, the UE receives and decodes PDSCH2. In the example illustrated in FIG. 2A, the UE reports HARQ-ACK for PDSCH 1 and PDSCH2 to the TRP1 and TRP2, respectively. The TRP1 and TRP 2 use different CORESETs and search spaces to transmit DCI scheduling PDSCH transmission to the UE. In such case, the NW may configure multiple CORESETs and search spaces. Each TRP may be associated with one or more CORESETs and also the related search spaces. With such configuration, the TRP may use the associated CORESET to transmit DCI to schedule a PDSCH transmission to the UE. The UE may be requested to decode DCI in CORESETs associated with either TRP to obtain PDSCH scheduling information.

Another example of multi-TRP transmission is illustrated in FIG. 2B. A UE receives PDSCH based on non-coherent joint transmission from two TRPs: TRP1 and TRP2. As illustrated in FIG. 2B, the TRP1 sends one DCI to schedule the transmission of PDSCH1 to the UE and the TRP2 sends one DCI to schedule the transmission of PDSCH2 to the UE. At the UE side, the UE receives and decodes DCI from both TRPs. Based on the DCI from TRP1, the UE receives and decodes PDSCH1 and based on the DCI from TRP2, the UE receive and decodes PDSCH2. In the example illustrated in FIG. 2B, the UE reports HARQ-ACK for both PDSCH1 and PDSCH2 to the TRP1, which is different from the HARQ-ACK reporting in the example illustrated in FIG. 2A. The example illustrated in FIG. 2B needs the ideal backhaul between the TRP1 and the TRP2, while the example illustrated in FIG. 2A may be deployed in the scenarios that the backhaul between the TRP1 and the TRP2 is ideal or non-ideal.

The NR/5G system supports the beam failure recovery function for both primary cells and secondary cells. In the specified beam failure recovery function for one cell, the UE monitors the beam quality of beam pair links of all the PDCCHs in one cell. To do that, the UE measures beam failure detection (BFD) reference signals (RSs) to detect the “beam failure” on one cell. The BFD RSs may be configured by the NW or derived by the UE based on QCL-type D configuration of all the CORESETs configured in that cell. The UE declares the beam failure of one cell when the hypocritical BLER measured on those BFD RSs is above a certain threshold. When beam failure is declared, the UE may report such an event to the system through a beam failure recovery request (BFRQ) message.

In a primary cell, the BFRQ message is a contention-free RACH transmission. If the UE detects beam failure and the UE also finds at least one new beam identification RS that has a reference signal received power (RSRP) larger than a configured threshold, the UE then transmits a random access channel (RACH) preamble in a given RACH resource occasion which is configured to be associated with one new beam identification RS that is selected by the UE. The transmission of that RACH preamble in a given RACH resource may be considered as a beam failure recovery request to the gNB. If the gNB detects such a RACH preamble successfully, the gNB may use QCL assumption of the new beam RS indicated by the detected RACH preamble to transmit PDCCH in a search space that is dedicated for beam failure recovery response. After sending the RACH preamble as a beam failure recovery request, the UE may begin to monitor PDCCH in the dedicated search space set. If valid DCI with a cyclic redundancy check (CRC) scrambled with the cell radio network temporary identity (C-RNTI) of the UE is detected, the UE may assume the gNB receives the beam failure request successfully. The UE monitors the PDCCH in the search space set dedicated for beam failure recovery by following the QCL assumption of q_{new} reported by the UE. After 28 symbols from the last symbol of the first PDCCH that is treated as the gNB's response to the BFRQ message from the UE, the UE may start to transmit a physical uplink control channel (PUCCH) using the same spatial filter as for the last PRACH transmission and the UE also assumes a pre-defined power control parameter on the PUCCH transmission.

In a secondary cell (SCell), the BFRQ message is a Media Access Control Control Element (MAC CE) message. When the UE declares the beam failure of one SCell, the UE may transmit a positive link recovery request (LRR) on the PUCCH resource configured through schedulingRequestIDForBFR that is a schedule request dedicated for SCell beam failure-recovery to request uplink grant from the gNB for transmitting step-2 message of SCell BFR. The UE sends a MAC CE of SCell BFR in one PUSCH transmission. In the MAC CE of SCell BFR, the UE includes the serving cell ID that meets beam failure and one channel state information reference signal (CSI-RS) resource index or SS/PBCH block index that is identified as new beam for the SCell. When the UE receives a DCI format scheduling a PUSCH transmission with the same HARQ process number as for the transmission of the SCell BFR MAC CE message and having a toggled NDI filed value, the UE may declare that the SCell BFR MAC CE message is received by the system successfully. After that, the UE may switch the transmit beam of PUCCH to a spatial filter that corresponding to the q_{new} reported in the MAC CE and the UE also switch the QCL assumption for receiving PDCCH of the SCell with beam failure to the q_{new} reported in the MAC CE.

The BFR functions specified in the current 3GPP specification only works for the single TRP case. In a multi-TRP system, the UE may receive PDCCH from two TRPs. If the current BFR method is merely applied in the multi-TRP system, the UE may declare beam failure only when all the CORESETs from both TRPs fail the beam and thus the UE reports the beam failure of one cell only when all the PDCCHs of both TRP meet beam failure. But, in general real-field deployment, different TRPs are located in different physical locations. Thus, it is expected that the beam failure of PDCCH of two TRPs may happen independently. For instance, when a first TRP experiences beam failure due to blockage, a second TRP does not have beam failure. If the current design of BFR is applied, the UE may not report the beam failure to the NW and thus the beam failure on the first TRP is not recovered.

To address the above problems, the technical solutions of the embodiments of the disclosure are provided. It is to be noted that although the technical solutions of the embodiments of the disclosure are described in terms of two TRPs, the technical solutions may also be applied for a larger number of TRPs.

To make the technical solutions of the embodiments of the disclosure to be understood better, the technical solutions of the disclosure are described below through the specific embodiments. The above relevant technology as optional solutions may be combined with the technical solutions of the embodiments of the disclosure in any way, and shall fall within the scope of protection of the disclosure. The embodiments of the disclosure include at least part of the following contents.

FIG. 3 is a schematic flowchart of a method for beam failure recovery according to an embodiment of the disclosure. As illustrated in FIG. 3, the method includes the following operations.

In 301, a UE obtains a first set of beam failure detection RSs and a second set of beam failure detection RSs. The first set of beam failure detection RSs is a source of QCL assumption for a PDCCH associated with a first TRP, and the second set of beam failure detection RSs is a source of QCL assumption for a PDCCH associated with a second TRP.

In 302, the UE performs beam failure detection and beam failure recovery for the first TRP according to the first set of beam failure detection RSs and performs beam failure detection and beam failure recovery for the second TRP according to the second set of beam failure detection RSs.

In the embodiment of the disclosure, the first set of beam failure detection RSs and the second first set of beam failure detection RSs may be obtained by the UE from the network side, or may be deduced by the UE.

In some implementation, the UE receives first configuration information and second configuration information, and obtains the first set of beam failure detection RSs according to the first configuration information and obtains the second set of beam failure detection RSs according to the second configuration information. The first configuration information is used to determine the first set of beam failure detection RSs, and the second configuration information is used to determine the second set of beam failure detection RSs.

In the embodiment of the disclosure, after the UE obtains the first set of beam failure detection RSs and the second set of beam failure detection RSs, the UE generates a first beam failure instance indication from a measurement result of the first set of beam failure detection RSs, and determines that beam failure of the first TRP happens when a number of consecutive first beam failure instance indications reaches a first threshold. And the UE generates a second beam failure instance indication from a measurement result of the second set of beam failure detection RSs, and determines that beam failure of the second TRP happens when a number of consecutive second beam failure instance indications reach a second threshold.

In some implementation, a physical layer in the UE measures radio link quality of the first set of beam failure detection RSs, and reports the first beam failure instance indication to a higher layer when the radio link quality of the first set of beam failure detection RSs is less than a third threshold. Further, the physical layer in the UE measures radio link quality of the second set of beam failure detection RSs, and reports the second beam failure instance indication to a higher layer when the radio link quality of the second set of beam failure detection RSs is less than a fourth threshold.

In some implementation, the UE receives third configuration information and fourth configuration information. The third configuration information is used to determine a third set of candidate beam RSs for the beam failure recovery of the first TRP, and the fourth configuration information is used to determine a fourth set of candidate beam RSs for the beam failure recovery of the second TRP. In such case, when beam failure for the first TRP is detected, the UE selects a first RS in the third set of candidate beam RSs for the beam failure recovery of the first TRP, in which radio link quality of the first RS is larger than or equal to the third threshold. When beam failure for the second TRP is detected, the UE selects a second RS in the fourth set of candidate beam RSs for the beam failure recovery of the second TRP, in which radio link quality of the second RS is larger than or equal to the fourth threshold.

The above technical solution of the embodiment of the disclosure implements configuration of the beam failure detection RSs at the granularity of TRP. The configuration of the beam failure detection RSs is further described below in combination with specific examples.

### Example 1

In an exemplary method, the UE may be configured to operate beam failure recovery for a serving cell where multi-TRP transmission is configured. For the PDCCH associated with a first TRP, the UE may be configured with a first set of beam failure detection RSs and for the PDCCH associated with a second TRP, the UE may be configured with a second set of beam failure detection RSs. If the UE is configured with the first set of beam failure detection RSs, the UE may be requested to determine the first set of beam failure detection RSs according to the RS configured as source of QCL assumption for the PDCCH of the first TRP. If the UE is configured with the second set of beam failure detection RSs, the UE may be requested to determine the second set of beam failure detection RSs according to the RS configured as source of QCL assumption for the PDCCH of the second TRP. Then the UE may be requested to assess the radio link quality according to the first set of beam failure detection RSs periodically and the UE may be requested to assess the radio link quality according to the second set of beam failure detection RSs periodically. The beam failure instance indication is generated separately for the first set of beam failure detection RSs and the second set of beam failure detection RSs. The physical layer in the UE provides an indication to higher layers when the radio link quality for all corresponding resource configurations in the first set of beam failure detection RSs that the UE uses to the radio link quality is worse than a threshold and the physical layer informs the higher layers when radio link quality measured from the first set of beam failure detection RSs is worse than the threshold with a determined periodicity. The physical layer in the UE provides an indication to higher layers when the radio link quality for all corresponding resource configurations in the second set of beam failure detection RSs that the UE uses to the radio link quality is worse than a threshold and the physical layer informs the higher layers when radio link quality measured from the second set of beam failure detection RSs is worse than the threshold with a determined periodicity. The UE may be requested to detect and declare beam failure of PDCCH of the first TRP and the second TRP separately. When the number of consecutive beam failure instance indication generated from the first set of beam failure detection RSs reaches a certain threshold, the UE may declare beam failure of the first TRP happens. When the number of consecutive beam failure instance indication generated from the second set of beam failure detection RSs reaches a certain threshold, the UE may declare beam failure of the second TRP happens.

The UE may also be configured with a third set of candidate beam RSs for the beam failure recovery of the first TRP and the UE may be configured with a fourth set of candidate beam RSs for the beam failure recovery of the second TRP. When beam failure for the first TRP is declared, the UE may be requested to find one RS (CSI-RS or SSB) in the third set of candidate beam RSs which has Layer 1 reference signal received power (L1-RSRP) measurement that is larger than or equal to a threshold. When beam failure for the second TRP is declared, the UE may be requested to find one RS (CSI-RS or SSB) in the fourth set of candidate beam RSs which has L1-RSRP measurement that is larger than or equal to a threshold.

In one example, the UE may be provided, for each Bandwidth Part (BWP) of a serving cell, a set q̅₀ of periodic CSI-RS resource configuration indexes by failureDetectionResources and a set q̅₁ of periodic CSI-RS resource configuration indexes and/or SS/PBCH block indexes by candidateBeamRSList or candidateBeamRSListExt-r16 or candidateBeamRSSCellList-r16 for radio link quality measurements on the BWP of the serving cell. When the UE is not provided q̅₀ by failureDetectionResources or beamFailureDetectionResourceList for a BWP of the serving cell, the UE determines the set q̅₀ to include periodic CSI-RS resource configuration indexes with same values as the RS indexes in the RS sets indicated by TCI-State for respective CORESETs that the UE uses for monitoring PDCCH and, if there are two RS indexes in a transmission configuration indicator (TCI) state, the set q̅₀ includes RS indexes with QCL-TypeD configuration for the corresponding TCI states. The UE expects the set q̅₀ to include up to two RS indexes. The UE expects a single port RS in the set q̅₀. The UE expects single-port or two-port CSI-RS with frequency density equal to 1 or 3 REs per RB in the set q̅₁.

For an BWP of serving cell, when the UE is not provided CORESETPoolIndex or is provided CORESETPoolIndex with a value of 0 for first CORESETs, and is provided CORESETPoolIndex with a value of 1 for second CORESETs, the UE may be provided with a set q̅_{0,0} of periodic CSI-RS configuration indexes and a set q̅_{1,0} of periodic CSI-RS resource configuration indexes and/or SS/PBCH block indexes that are associated with the CORESETPoolIndex with a value of 0 and a set q̅_{0,1} of periodic CSI-RS configuration indexes and a set q̅_{1,1} of periodic CSI-RS resource configuration indexes and/or SS/PBCH block indexes that is associated with the CORESETPoolIndex with a value of 1. If the UE is not provided with q̅_{0,0}, the UE determines the set q̅_{0,0} to include periodic CSI-RS resource configuration indexes with same values as the RS indexes in the RS sets indicated by TCI-State for respective CORESETs configured or associated with CORESETPoolIndex with a value of 0 that the UE uses for monitoring PDCCH and, if there are two RS indexes in a TCI state, the set q̅_{0,0} includes RS indexes with QCL-TypeD configuration for the corresponding TCI states. When the UE is not provided with q̅_{0,1} the UE determines the set q̅_{0,0} to include periodic CSI-RS resource configuration indexes with same values as the RS indexes in the RS sets indicated by TCI-State for respective CORESETs configured or associated with CORESETPoolIndex with a value of 1 that the UE uses for monitoring PDCCH and, if there are two RS indexes in a TCI state, the set q̅_{0,1} includes RS indexes with QCL-TypeD configuration for the corresponding TCI states.

The UE expects the sets q̅_{0,0} and q̅_{0,1} to include up to two RS indexes. The UE expects a single port RS in the set q̅_{0,0} and q̅_{0,1}. The UE expects single-port or two-port CSI-RS with frequency density equal to 1 or 3 REs per RB in the set q̅_{1,0} and q̅₀.

In one example, the physical layer in the UE assesses the radio link quality according to the set q̅₀ of resource configurations against the threshold Q_{out,LR}. For the set q̅₀, the UE assesses the radio link quality only according to periodic CSI-RS resource configurations, or SS/PBCH blocks on a primary cell (PCell) or primary secondary cell (PSCell), that are quasi co-located, as described in TS 38.214, with the DM-RS of PDCCH receptions monitored by the UE. The UE applies the threshold Q_{in,LR} to the L1-RSRP measurement obtained from an SS/PBCH block. The UE applies the threshold Q_{in,LR} to the L1-RSRP measurement obtained for a CSI-RS resource after scaling a respective CSI-RS reception power with a value provided by powerControlOffsetSS.

In an BWP of serving cell, when the UE is not provided CORESETPoolIndex or is provided CORESETPoolIndex with a value of 0 for first CORESETs, and is provided CORESETPoolIndex with a value of 1 for second CORESETs, the physical layer in the UE assesses the radio link quality according to the set q̅_{0,0} of resource configurations against the threshold Q_{out,LR} and assesses the radio link quality according to the set q̅_{0,1} of resource configurations against the threshold Q_{out,LR}. For the set q̅_{0,0}, the UE assesses the radio link quality only according to periodic CSI-RS resource configurations, or SS/PBCH blocks on the PCell or the PSCell, that are quasi co-located, as described in TS 38.214, with the DM-RS of PDCCH receptions monitored by the UE in the search space sets associated with CORESETs configured or associated with CORESETPoolIndex with a value of 0. For the set q̅_{0,1} the UE assesses the radio link quality only according to periodic CSI-RS resource configurations, or SS/PBCH blocks on the PCell or the PSCell, that are quasi co-located, as described in TS 38.214, with the DM-RS of PDCCH receptions monitored by the UE in the search space sets associated with CORESETs configured or associated with CORESETPoolIndex with a value of 1.

In one example, in non-DRX mode operation, the physical layer in the UE provides an indication to higher layers when the radio link quality for all corresponding resource configurations in the set go that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity among the periodic CSI-RS configurations, and/or SS/PBCH blocks on the PCell or the PSCell, in the set go that the UE uses to assess the radio link quality and 2 msec. In DRX mode operation, the physical layer provides an indication to higher layers when the radio link quality is worse than the threshold Q_{out,LR} with a periodicity determined as described in TS 38.133.

In an BWP of serving cell, when the UE is not provided CORESETPoolIndex or is provided CORESETPoolIndex with a value of 0 for first CORESETs, and is provided CORESETPoolIndex with a value of 1 for second CORESETs, the physical layer in the UE provides an indication to higher layers when the radio link quality for all corresponding resource configurations in the set q̅_{0,0} is worse than the threshold Q_{out,LR} and the physical layer in the UE provides an indication to higher layers when the radio link quality for all corresponding resource configurations in the set q̅_{0,1} is worse than the threshold Q_{out,LR}. The indication provided to the higher layers may include an indicator that indicates whether the indication is for the set q̅_{0,1} or q̅_{0,1}. In other words, the indication provided to the higher layers may include an indicator that indicates the corresponding CORESETPoolIndex value.

In non-DRX mode operation, the physical layer in the UE provides an indication to higher layers when the radio link quality for all corresponding resource configurations in the set q̅_{0,1} that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity among the periodic CSI-RS configurations, and/or SS/PBCH blocks on the PCell or the PSCell, in the set q̅_{0,0} that the UE uses to assess the radio link quality and 2 msec. And the physical layer in the UE provides an indication to higher layers when the radio link quality for all corresponding resource configurations in the set q̅_{0,1} that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity among the periodic CSI-RS configurations, and/or SS/PBCH blocks on the PCell or the PSCell, in the set q̅_{0,1} that the UE uses to assess the radio link quality and 2 msec.

In DRX mode operation, the physical layer provides an indication to higher layers when the radio link quality for all corresponding resource configurations in the set q̅_{0,0} is worse than the threshold Q_{out,LR} with a periodicity determined as described in TS 38.133. The physical layer provides an indication to higher layers when the radio link quality for all corresponding resource configurations in the set q̅_{0,1} is worse than the threshold Q_{out,LR} with a periodicity determined as described in TS 38.133

For the PCell or the PSCell, upon request from higher layers, the UE provides to higher layers the periodic CSI-RS configuration indexes and/or SS/PBCH block indexes from the set q̅₁ and the corresponding L1-RSRP measurements that are larger than or equal to the threshold Q_{in,LR}.

For the SCell, upon request from higher layers, the UE indicates to higher layers whether there is at least one periodic CSI-RS configuration index and/or SS/PBCH block index from the set q̅₁ with corresponding L1-RSRP measurements that are larger than or equal to the threshold Q_{in,LR}, and provides the periodic CSI-RS configuration indexes and/or SS/PBCH block indexes from the set q̅₁ and the corresponding L1-RSRP measurements that are larger than or equal to the threshold Q_{in,LR}, if any.

In an BWP of serving cell, when the UE is not provided CORESETPoolIndex or is provided CORESETPoolIndex with a value of 0 for first CORESETs, and is provided CORESETPoolIndex with a value of 1 for second CORESETs, upon the request from higher layers that indicates an indicator for the set q̅_{1,0}, or q̅_{1,1} the UE indicates to higher layers whether there is at least one periodic CSI-RS configuration index and/or SS/PBCH block index from the set q̅_{1,0} or q̅_{1,1} as indicated by the higher layers with corresponding L1-RSRP measurements that are larger than or equal to the threshold Q_{in,LR}, and provides the periodic CSI-RS configuration indexes and/or SS/PBCH block indexes from the set q̅_{1,0} or q̅_{1,1} as indicated by the higher layers and the corresponding L1-RSRP measurements that are larger than or equal to the threshold Q_{in,LR}, if any.

In the embodiment of the disclosure, the UE may report beam failure of the first TRP and/or beam failure of the second TRP to the network after the beam failure of the first TRP and/or beam failure of the second TRP is detected. Reporting of beam failure of the first TRP and/or beam failure of the second TRP by the UE to the network will be described below in combination with different solutions.

First solution: the UE sends at least one of a first MAC CE or a second MAC CE to a network device. The first MAC CE is used to report the beam failure of the first TRP to the network device, and the second MAC CE is used to report the beam failure of the second TRP to the network device.

The first MAC CE includes at least one of: first information used for determining a serving cell index for a cell where beam failure is detected; second information used for determining an index of the first TRP where beam failure is detected; third information used for indicating whether a candidate reference signal identity (RS ID) is included in the first MAC CE; or fourth information. The fourth information is a candidate RS ID.

The second MAC CE includes at least one of: first information used for determining a serving cell index for a cell where beam failure is detected; second information used for determining an index of the second TRP where beam failure is detected; third information used for indicating whether a candidate RS ID is included in the second MAC CE; or fourth information that is a candidate RS ID.

In the above solution, as an example, the first information is a first bitmap. The first bitmap includes a plurality of bits, each of the plurality of bits corresponds to a service cell index, and a value of each bit indicates whether the beam failure is detected in a cell indicated by the service cell index corresponding to the bit.

In the above solution, as an example, the second information is a value of a CORESET pool index coresetPoolIndex, and coresetPoolIndex is an index of a CORESET associated with a PDCCH for a TRP where the beam failure is detected.

Second solution: the UE sends at least one of a first Physical Random Access Channel (PRACH) transmission according to a first PRACH dedicated resource or a second PRACH transmission according to a second PRACH dedicated resource to a network device. The first PRACH transmission is used to report the beam failure of the first TRP to the network device, and the second PRACH transmission is used to report the beam failure of the second TRP to the network device.

The first PRACH dedicated resource is a PRACH dedicated resource used for the first TRP to perform the beam failure recovery.

The second PRACH dedicated resource is a PRACH dedicated resource used for the second TRP to perform the beam failure recovery.

In some implementation, after sending at least one of the first PRACH transmission or the second PRACH transmission, the UE monitors a PDCCH in a first search space set within a first window, and obtains first downlink control information (DCI) from the monitored PDCCH. The first DCI is scrambled by a cell radio network temporary identity (C-RNTI) or modulation and coding scheme (MCS)-C-RNTI. Herein, the first search space set is determined according to a recovery search space identity recoverySearchSpaceId. The first window is determined according to a beam failure recovery configuration. The first PRACH transmission or the second PRACH transmission is in a slot n, and the first window starts from a slot n+k. n and k both are positive integers.

Third solution: the UE sends a first PRACH transmission according to a first PRACH dedicated resource to a network device, the first PRACH transmission being used to report the beam failure of the first TRP to the network device; and/or, the UE sends a second MAC CE to the network device, the second MAC CE being used to report the beam failure of the second TRP to the network device.

Herein, the first PRACH dedicated resource is a PRACH dedicated resource used for the first TRP to perform the beam failure recovery.

The second MAC CE includes at least one of: first information used for determining a serving cell index for a cell where beam failure is detected; second information used for determining an index of the second TRP where beam failure is detected; third information used for indicating whether a candidate RS ID is included in the second MAC CE; or fourth information that is a candidate RS ID.

In some implementation, after sending the first PRACH transmission, the UE monitors a PDCCH in a first search space set within a first window, and obtains first DCI from the monitored PDCCH. The first DCI is scrambled by a C-RNTI or MCS-C-RNTI. Herein, the first search space set is determined according to a recovery search space identity recoverySearchSpaceId. The first window is determined according to a beam failure recovery configuration. The first PRACH transmission is in a slot n, and the first window starts from a slot n+k. n and k both are positive integers.

In the above solution, as an example, the first information is a first bitmap. The first bitmap includes a plurality of bits, each of the plurality of bits corresponds to a service cell index, and a value of each bit indicates whether the beam failure is detected in a cell indicated by the service cell index corresponding to the bit.

In the above solution, as an example, the second information is a value of a CORESET pool index coresetPoolIndex, and coresetPoolIndex is an index of a CORESET associated with a PDCCH for a TRP where the beam failure is detected.

The above technical solution of the embodiment of the disclosure implements reporting of the beam failure at the granularity of TRP. The reporting of the beam failure is further described below in combination with specific examples.

### Example 2

In an exemplary method, the UE may use one MAC CE to report the beam failure of PDCCH of a TRP to the system. In one example, the UE is configured with multi-TRP transmission and the UE is configured to operate beam failure recovery on PDCCH of each TRP separately. When the UE detects beam failure on the PDCCH of a TRP, the UE may be requested to report such event to the system. In the MAC CE, the UE may be requested to include one or more of the following information:

1) A serving cell index for the Cell where beam failure is detected.

2) An indicator to indicate the index of TRP where beam failure is detected. In one example, this information element may be the value of higher layer parameter CORESETPoolIndex associated with the PDCCHs of the TRP.

3) An indicator to indicate whether a candidate RS ID is included.

4) A candidate RS ID that is used to provide one RS ID for the candidate beam RS.

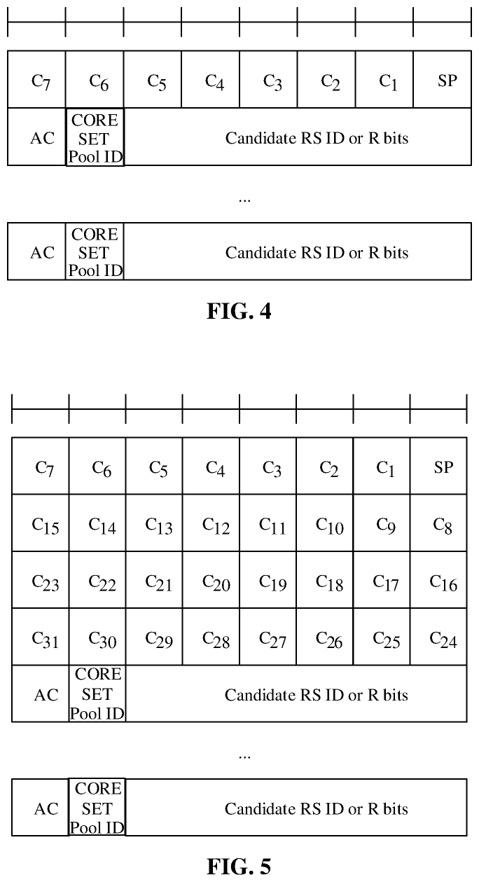

Examples of MAC CE reporting beam failure for a multi-TRP system are illustrated in FIG. 4 and FIG. 5.

As illustrated in FIG. 4 and FIG. 5, the MAC CE may include a bitmap and in ascending order based on the serving cell index of Cells ServCellIndex, beam failure recovery information, i.e. octets containing candidate beam availability indication (AC) for Cells indicated in the bitmap. In FIG. 4, a single octet bitmap is used when the highest ServCellIndex of this MAC entity's SCell for which beam failure is detected is less than 8, otherwise four octets are used as illustrated in FIG. 5. The MAC CE contains the following elements:

1) Ci: This field indicates beam failure detection (as specified in clause 5.17) and the presence of an octet containing the AC field for the serving cell with ServCellIndex i. The Ci field set to 1 indicates that beam failure is detected and the octet containing the AC field is present for the Cell with ServCellIndex i. The Ci field set to 0 indicates that the beam failure is not detected and octet containing the AC field is not present for the serving cell with ServCellIndex i. The octets containing the AC field are present in ascending order based on the ServCellIndex.

2) AC: This field indicates presence of the Candidate RS ID field in this octet. If at least one of the SSBs with SS-RSRP above a configured threshold amongst the SSBs in the configured candidate beam RS list or the CSI-RSs with CSI-RSRP above a configured threshold amongst the CSI-RSs in configured candidate beam RS list is available, the AC field is set to 1; otherwise, it is set to 0. If the AC field set to 1, the Candidate RS ID field is present. If the AC field set to 0, R bits are present instead.

3) Candidate RS ID: This field is set to the index of an SSB with SS-RSRP above a configured threshold amongst the SSBs in the configured candidate beam RS list or to the index of a CSI-RS with CSI-RSRP above a configured threshold amongst the CSI-RSs in the configured candidate beam RS list. The length of this field is 6 bits.

4) CORESET Pool ID: This field indicates that the beam failure detection and reported candidate RS ID if presented are specific to the ControlResourceSetId configured with CORESET Pool ID as specified in TS 38.331.

This field set to 1 indicates that the MAC CE may be applied for the CORESETs with the CORESET pool ID equal to 1, otherwise, the MAC CE may be applied for the PDCCH with CORESET pool ID equal to 0.

If the coresetPoolIndex is not configured for any CORESET, the MAC entity may ignore the CORESET Pool ID field in this MAC CE when receiving the MAC CE.

5) R: Reserved bit, set to 0.

In an exemplary method, the UE may be provided, by schedulingRequestID-BFR-SCell-r16, a configuration for PUCCH transmission with a LRR. The UE may transmit in a first PUSCH MAC CE providing index(es) for at least corresponding serving cell(s) with radio link quality worse than Q_{out,LR}, indication(s) of presence of q_{new} for corresponding serving cell(s), an indicator of CORESETPoolIndex value and index(es) q_{new} for a periodic CSI-RS configuration or for an SS/PBCH block provided by higher layers, if any, for corresponding serving cell. After 28 symbols from a last symbol of a PDCCH reception with a DCI format scheduling a PUSCH transmission with a same HARQ process number as for the transmission of the first PUSCH and having a toggled NDI field value, the UE:

1) monitors PDCCH in all CORESETs on the serving cell indicated by the MAC CE that are configured/associated with the same CORESETPoolIndex value indicated by the MAC CE using the same antenna port quasi co-location parameters as the ones associated with the corresponding index(es) q_{new}, if any;

2) monitors all PDSCH that are scheduled by PDCCH configured/associated with the same CORESETPoolIndex value indicated by the MAC CE using the same antenna port quasi co-location parameters as the ones associated with the corresponding index(es) q_{new}, if any;

3) transmits PUCCH on PUCCH transmissions associated with the same CORESETPoolIndex value indicated by the MAC CE using a same spatial domain filter as the one corresponding to q_{new} for periodic CSI-RS or SS/PBCH block reception, and using a power determined with qᵤ=0, q_{d}=q_{new}, and l=0.

The SCS configuration for the 28 symbols is the smallest of the SCS configurations of the active DL BWP for the PDCCH reception and of the active DL BWP(s) of the at least one SCell.

### Example 3

In an exemplary method, for the PCell or the PSCell, when the UE is not provided CORESETPoolIndex or is provided CORESETPoolIndex with a value of 0 for first CORESETs, and is provided CORESETPoolIndex with a value of 1 for second CORESETs, the UE may be provided, by PRACH-ResourceDedicatedBFR, and PRACH-ResourceDedicatedBFR2nd, a configuration for PRACH transmission for PDCCH configured/associated with CORESETPoolIndex with a value 0 and 1, respectively. For PRACH transmission in slot n and according to antenna port quasi co-location parameters associated with periodic CSI-RS resource configuration or with SS/PBCH block associated with index q_{new} provided by higher layers, the UE monitors PDCCH in a search space set provided by recoverySearchSpaceId for detection of a DCI format with CRC scrambled by C-RNTI or MCS-C-RNTI starting from slot n+4 within a window configured by BeamFailureRecoveryConfig. For PDCCH monitoring in a search space set provided by recoverySearchSpaceId and for corresponding PDSCH reception, the UE assumes the same antenna port quasi-collocation parameters as the ones associated with index q_{new} until the UE receives by higher layers an activation for a TCI state or any of the parameters tci-StatesPDCCH-ToAddList and/or tci-StatesPDCCH-ToReleaseList. After the UE detects a DCI format with CRC scrambled by C-RNTI or MCS-C-RNTI in the search space set provided by recoverySearchSpaceId, the UE continues to monitor PDCCH candidates in the search space set provided by recoverySearchSpaceId until the UE receives a MAC CE activation command for a TCI state or tci-StatesPDCCH-ToAddList and/or tci-StatesPDCCH-ToReleaseList.

In one alternative example, for PRACH transmission based on configuration PRACH-ResourceDedicatedBFR or PRACH-ResourceDedicatedBFR2nd in slot n and according to antenna port quasi co-location parameters associated with periodic CSI-RS resource configuration or with SS/PBCH block associated with index q_{new} provided by higher layers, the UE monitors PDCCH in a search space set provided by recoverySearchSpaceId or recoverySearchSpaceId2nd for detection of a DCI format with CRC scrambled by C-RNTI or MCS-C-RNTI starting from slot n+4 within a window. For PDCCH monitoring in a search space set provided by recoverySearchSpaceId or recoverySearchSpaceId2nd and for corresponding PDSCH reception, the UE assumes the same antenna port quasi-collocation parameters as the ones associated with index q_{new} until the UE receives by higher layers an activation for a TCI state or any of the parameters tci-StatesPDCCH-ToAddList and/or tci-StatesPDCCH-ToReleaseList. After the UE detects a DCI format with CRC scrambled by C-RNTI or MCS-C-RNTI in the search space set provided by recoverySearchSpaceId or recoverySearchSpaceId2nd, the UE continues to monitor PDCCH candidates in the search space set provided by recoverySearchSpaceId or recoverySearchSpaceId2nd until the UE receives a MAC CE activation command for a TCI state or tci-StatesPDCCH-ToAddList and/or tci-StatesPDCCH-ToReleaseList for a CORESET configured/associated with CORESETPoolIndex with a value of 0 or 1.

For the PCell or the PSCell, after 28 symbols from a last symbol of a first PDCCH reception in a search space set provided by recoverySearchSpaceId (or recoverySearchSpaceId2nd) for which the UE detects a DCI format with CRC scrambled by C-RNTI or MCS-C-RNTI and until the UE receives an activation command for PUCCH-SpatialRelationInfo [11, TS 38.321] or is provided PUCCH-SpatialRelationInfo for PUCCH resource(s), the UE transmits a PUCCH associated with the same CORESETPoolIndex value as the PRACH transmission on a same cell as the PRACH transmission using: 1) a same spatial filter as for the last PRACH transmission; 2) a power determined as described in Clause 7.2.1 with qᵤ=0, q_{d}=q_{new}, and l=0.

For the PCell or the PSCell, after 28 symbols from a last symbol of a first PDCCH reception in a search space set provided by recoverySearchSpaceId where the UE detects a DCI format with CRC scrambled by C-RNTI or MCS-C-RNTI, the UE assumes same antenna port quasi-collocation parameters as the ones associated with index q_{new} for PDCCH monitoring in a CORESET with index 0.

When the UE is not provided CORESETPoolIndex or is provided CORESETPoolIndex with a value of 0 for first CORESETs, and is provided CORESETPoolIndex with a value of 1 for second CORESETs, if the PRACH transmission is associated with CORESETPoolIndex having a value of 0, after 28 symbols from a last symbol of a first PDCCH reception in a search space set provided by recoverySearchSpaceId where the UE detects a DCI format with CRC scrambled by C-RNTI or MCS-C-RNTI, the UE assumes same antenna port quasi-collocation parameters as the ones associated with index q_{new} for PDCCH monitoring in a CORESET with index 0.

### Example 4

In one method, for UE configured with multi-TRP transmission, the UE may be configured to use the RACH-based method to report the beam failure recovery event of the first TRP and the UE may be configured to use the MAC CE based method to report the beam failure recovery event of the second TRP.

In a BWP of PCell or PSCell, when the UE is not provided CORESETPoolIndex or is provided CORESETPoolIndex with a value of 0 for first CORESETs, and is provided CORESETPoolIndex with a value of 1 for second CORESETs, the following may be performed.

For the beam failure of CORESET(s) configured or associated with CORESETPoolIndex with a value of 0, the UE may be provided, by PRACH-ResourceDedicatedBFR, a configuration for PRACH transmission. For PRACH transmission in slot n and according to antenna port quasi co-location parameters associated with periodic CSI-RS resource configuration or with SS/PBCH block associated with index q_{new} provided by higher layers, the UE monitors PDCCH in a search space set provided by recoverySearchSpaceId for detection of a DCI format with CRC scrambled by C-RNTI or MCS-C-RNTI starting from slot n+4 within a window configured by BeamFailureRecoveryConfig. For PDCCH monitoring in a search space set provided by recoverySearchSpaceId and for corresponding PDSCH reception, the UE assumes the same antenna port quasi-collocation parameters as the ones associated with index q_{new} until the UE receives by higher layers an activation for a TCI state or any of the parameters tci-StatesPDCCH-ToAddList and/or tci-StatesPDCCH-ToReleaseList. After the UE detects a DCI format with CRC scrambled by C-RNTI or MCS-C-RNTI in the search space set provided by recoverySearchSpaceId, the UE continues to monitor PDCCH candidates in the search space set provided by recoverySearchSpaceId until the UE receives a MAC CE activation command for a TCI state or tci-StatesPDCCH-ToAddList and/or tci-StatesPDCCH-ToReleaseList.

After 28 symbols from a last symbol of a first PDCCH reception in a search space set provided by recoverySearchSpaceId for which the UE detects a DCI format with CRC scrambled by C-RNTI or MCS-C-RNTI and until the UE receives an activation command for PUCCH-SpatialRelationInfo or is provided PUCCH-SpatialRelationInfo for PUCCH resource(s), the UE transmits a PUCCH associated with CORESETPoolIndex with value 0 on a same cell as the PRACH transmission using: i) a same spatial filter as for the last PRACH transmission; ii) a power determined with qᵤ=0, q_{d}=q_{new}, and l=0

For the PCell or the PSCell, after 28 symbols from a last symbol of a first PDCCH reception in a search space set provided by recoverySearchSpaceId where the UE detects a DCI format with CRC scrambled by C-RNTI or MCS-C-RNTI, the UE assumes same antenna port quasi-collocation parameters as the ones associated with index q_{new} for PDCCH monitoring in a CORESET with index 0.

For the beam failure of CORESET(s) configured or associated with CORESETPoolIndex with a value of 1, the UE may be provided, by schedulingRequestID-BFR-SCell-r16, a configuration for PUCCH transmission with a LRR. The UE may transmit in a first PUSCH MAC CE providing index(es) for at least corresponding serving cell(s) with radio link quality worse than Q_{out,LR}, CORESET Pool ID, indication(s) of presence of q_{new} for corresponding serving cell(s), and index(es) q_{new} for a periodic CSI-RS configuration or for an SS/PBCH block provided by higher layers, if any. After 28 symbols from a last symbol of a PDCCH reception with a DCI format scheduling a PUSCH transmission with a same HARQ process number as for the transmission of the first PUSCH and having a toggled NDI field value, the UE:

1) monitors PDCCH in all CORESETs associated with the CORESET Pool ID indicated by the MAC CE on the serving cell(s) indicated by the MAC CE using the same antenna port quasi co-location parameters as the ones associated with the corresponding index(es) q_{new}, if any;

2) transmits PUCCH associated with the same CORESET Pool ID indicated by the MAC CE on serving cell(s) using a same spatial domain filter as the one corresponding to q_{new} for periodic CSI-RS or SS/PBCH block reception, and using a power determined as described in Clause 7.2.1 with qᵤ=0, q_{d}=q_{new}, and l=0.

The above technical solution of the embodiments of the disclosure implements the beam failure detection and the beam failure reporting at the granularity of TRP. Further, the beam failure detection may also be performed at the granularity of CORESET, and the beam failure corresponding to the beam failure detection may be reported at the granularity of CORESET.

Specifically, the UE obtains a beam failure detection RS for each CORESET in a first CORESET pool and performs, according to the beam failure detection RS for each CORESET, beam failure detection for the CORESET, in which the first CORESET pool is a CORESET pool associated with a PDCCH of the first TRP. The UE obtains a beam failure detection RS for each CORESET in a second CORESET pool and performs, according to the beam failure detection RS for each CORESET, beam failure detection for the CORESET. The second CORESET pool is a CORESET pool associated with a PDCCH of the second TRP. When the UE detects beam failure for one or more CORESETs, the UE reports the beam failure for one or more CORESETs to the network device. In some implementation, the UE reports the beam failure for one or more CORESETs to the network device through a MAC CE or uplink control information (UCI).

The beam failure detection and the beam failure reporting performed at the granularity of CORESET will be further described in combination with specific examples.

### Example 5

In an exemplary method, the UE may be configured to operate beam failure recovery on each CORESET. In a BWP of a serving cell, the UE may be configured with one or more CORESET(s). The UE may be configured to operate per-CORESET BFR on those CORESET.

In a first example, the UE may be configured with beam failure detection RS for each CORESET. For that, the UE may be provided with a periodic CSI-RS resource configuration index q₀ and a set q̅₁ of periodic CSI-RS resource configuration indexes and/or SS/PBCH block indexes for radio link quality measurements on the BWP of the serving cell. The same set q̅₁ may be configured for one or more CORESET. When the UE is not provided q₀ for one CORESET, the UE determines the q₀ to include periodic CSI-RS resource configuration indexes with same values as the RS indexes in the RS sets indicated by TCI-State for respective CORESET that the UE uses for monitoring PDCCH and, if there are two RS indexes in a TCI state, the q₀ may be the RS index with QCL-TypeD configuration for the corresponding TCI state. The UE expects a single port RS in q₀. The UE expects single-port or two-port CSI-RS with frequency density equal to 1 or 3 REs per RB in the set q̅₁.

The physical layer in the UE assesses the radio link quality according to RS q₀ against the threshold Q_{out,LR} for the corresponding CORESET. The UE applies the threshold Q_{in,LR} to the L1-RSRP measurement obtained from an SS/PBCH block. The UE applies the threshold Q_{in,LR} to the L1-RSRP measurement obtained for a CSI-RS resource after scaling a respective CSI-RS reception power with a value provided by powerControlOffsetSS.

In non-DRX mode operation, the physical layer in the UE provides an indication to higher layers when the radio link quality for corresponding resource configuration in q₀ that the UE uses to assess the radio link quality is worse than the threshold Q_{out,LR}. The physical layer informs the higher layers when the radio link quality is worse than the threshold Q_{out,LR} with a periodicity determined by the maximum between the periodicity of the periodic CSI-RS configurations, or SS/PBCH blocks on the PCell or the PSCell of q₀ that the UE uses to assess the radio link quality and 2 msec. In DRX mode operation, the physical layer provides an indication to higher layers when the radio link quality is worse than the threshold Q_{out,LR} with a periodicity determined as described in [10, TS 38.133].

In a second example, when the UE detects beam failure for one CORESET, the UE may be requested to report that information to the system through a MAC CE or UCI. For example, in a MAC CE, the UE may be requested to report one or more of following information:

1) Serving cell index of the cell where beam failure is detected on a certain CORESET.

2) The controlResourceSetId of the CORESET where beam failure is detected.

3) An indicator to indicate whether an identified new beam RS is present in the MAC CE.

4) An index of identified new beam RS q_{new}.

The UE may be provided, by schedulingRequestID-BFR-SCell-r16, a configuration for PUCCH transmission with a LRR. The UE may transmit in a first PUSCH MAC CE providing index(es) for at least corresponding serving cell(s) with radio link quality worse than Q_{out,LR}, control resource Id of the CORESET with radio link quality worse than Q_{out,LR}, indication(s) of presence of q_{new} for corresponding serving cell(s), and index(es) q_{new} for a periodic CSI-RS configuration or for an SS/PBCH block provided by higher layer, if any, for corresponding serving cell. After 28 symbols from a last symbol of a PDCCH reception with a DCI format scheduling a PUSCH transmission with a same HARQ process number as for the transmission of the first PUSCH and having a toggled NDI field value, the UE monitors PDCCH in the CORESET indicated by the MAC CE on the serving cell(s) indicated by the MAC CE using the same antenna port quasi co-location parameters as the ones associated with the corresponding index(es) q_{new}, if any.

The present disclosure provides the following methods for SCell beam failure recovery in a multi-TRP system.

In the multi-TRP system, the UE is provided or may derive set of beam failure detection RS for CORESET associated with CORESETPoolIndex=0 and CORESETPoolIndex=1, respectively and the then detect the beam failure on the PDCCH associated with CORESETPoolIndex=0 and CORESETPoolIndex=1 independently. For CORESETs associated with CORESETPoolIndex=0 and CORESETPoolIndex=1, the UE may be provided with candidate beam reference signal set, respectively. 1) The UE is configured with separate RACH configuration and search space set for beam failure recovery for two different TRPs. 2) The UE may use MAC CE to report the per-TRP beam failure recovery. 3) The UE may use the RACH based method for the beam failure recovery of the first TRP and use the MAC CE based method for the beam failure recovery of the second TRP.

In one method, the UE operates beam failure detection on each individual CORESET separately and when beam failure is detected for one CORESET, the UE reports the event of beam failure of that CORESET to the system.

The embodiments of the disclosure have been described in detail above in combination with the accompanying drawings, but the disclosure is not limited to the specific details in the above embodiments. Any variations may be made within the technical conception of the present disclosure and shall fall within the scope of protection of the disclosure. For example, the various specific technical features described in the above embodiments may be combined in any suitable way without conflict, and the various possible combinations are not described separately in order to avoid unnecessary repetition. For example, the various embodiments of the disclosure may also be combined in any manner without departing from the concept of the disclosure and the resulting technical solutions shall also fall within the scope of protection of the disclosure. For another example, the various embodiments and/or the technical features of the various embodiments in the disclosure may be combined with the related art in any manner without conflict, and the resulting technical solutions shall also fall within the scope of protection of the disclosure.

It is also to be understood that in various embodiments of the disclosure, a magnitude of a sequence number of each process does not mean an execution sequence and the execution sequence of each process should be determined by its function and an internal logic and should not form any limit to an implementation process of the embodiments of the disclosure. Furthermore, in the embodiments, the terms “downlink”, “uplink” and “sidelink” are used to indicate a direction of transmission of signals or data, “downlink” is used to indicate that the signal or data is transmitted in a first direction from a station to a UE of a cell, “uplink” is used to indicate that the signal or data is transmitted in a second direction from a UE of a cell to a station, and “sidelink” is used to indicate that the signal or data is transmitted in a third direction from UE 1 to UE 2. For example, “downlink signal” indicates that the signal is transmitted in the first direction.

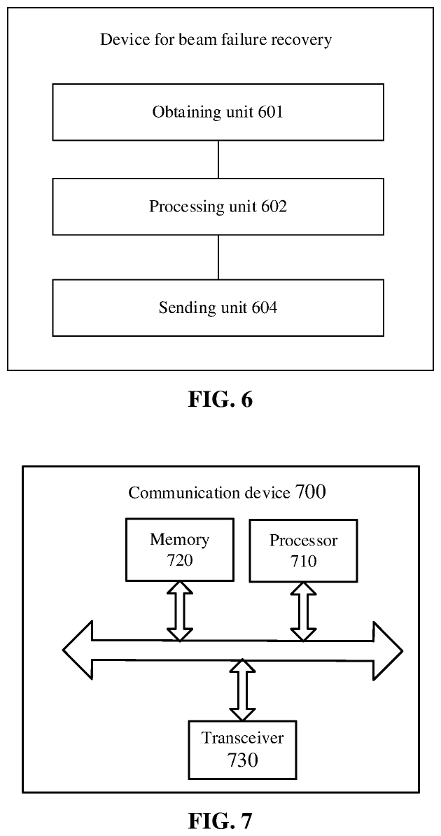

FIG. 6 is a schematic structure diagram of a device for beam failure recovery according to an embodiment of the disclosure, which is applied to a UE. As illustrated in FIG. 6, the device includes an obtaining unit 601 and a processing unit 602.

The obtaining unit 601 is configured to obtain a first set of beam failure detection RSs and a second set of beam failure detection RSs. The first set of beam failure detection RSs is a source of QCL assumption for a PDCCH associated with a first TRP, and the second set of beam failure detection RSs is a source of QCL assumption for a PDCCH associated with a second TRP.

The processing unit is configured to perform beam failure detection and beam failure recovery for the first TRP according to the first set of beam failure detection RSs and perform beam failure detection and beam failure recovery for the second TRP according to the second set of beam failure detection RSs.

In some implementation, the device may include a receiving unit 603. The receiving unit 603 is configured to receive first configuration information and second configuration information. The first configuration information is used to determine the first set of beam failure detection RSs, and the second configuration information is used to determine the second set of beam failure detection RSs.

The obtaining unit 601 is configured to obtain the first set of beam failure detection RSs according to the first configuration information and obtain the second set of beam failure detection RSs according to the second configuration information.

In some implementation, the processing unit 602 is configured to generate a first beam failure instance indication from a measurement result of the first set of beam failure detection RSs, and determine that beam failure of the first TRP happens when a number of consecutive first beam failure instance indications reaches a first threshold. The the processing unit 602 is configured to generate a second beam failure instance indication from a measurement result of the second set of beam failure detection RSs, and determine that beam failure of the second TRP happens when a number of consecutive second beam failure instance indications reaches a second threshold.

In some implementation, the processing unit 602 is configured to control a physical layer in the UE to measure radio link quality of the first set of beam failure detection RSs, and report the first beam failure instance indication to a higher layer when the radio link quality of the first set of beam failure detection RSs is less than a third threshold. The processing unit 602 is configured to control a physical layer in the UE to measure radio link quality of the second set of beam failure detection RSs, and report the second beam failure instance indication to a higher layer when the radio link quality of the second set of beam failure detection RSs is less than a fourth threshold.

In some implementation, the device may include a receiving unit 603. The receiving unit 603 is configured to receive third configuration information and fourth configuration information. The third configuration information is used to determine a third set of candidate beam RSs for the beam failure recovery of the first TRP, and the fourth configuration information is used to determine a fourth set of candidate beam RSs for the beam failure recovery of the second TRP.

In some implementation, the processing unit 602 is configured to select, when beam failure for the first TRP is detected, a first RS in the third set of candidate beam RSs for the beam failure recovery of the first TRP. Radio link quality of the first RS is larger than or equal to a third threshold. And/or, the processing unit 602 is configured to select, when beam failure for the second TRP is detected, a second RS in the fourth set of candidate beam RSs for the beam failure recovery of the second TRP. Radio link quality of the second RS is larger than or equal to a fourth threshold.

In some implementation, the device may include a sending unit 604. The sending unit 604 is configured to send at least one of a first MAC CE or a second MAC CE to a network device. The first MAC CE is used to report the beam failure of the first TRP to the network device, and the second MAC CE is used to report the beam failure of the second TRP to the network device.

In some implementation, the device may include a sending unit 604. The sending unit 604 is configured to send at least one of a first PRACH transmission to a network device according to a first PRACH dedicated resource or a second PRACH transmission to the network device according to a second PRACH dedicated resource. The first PRACH transmission is used to report the beam failure of the first TRP to the network device, and the second PRACH transmission is used to report the beam failure of the second TRP to the network device

In some implementation, the device may include a sending unit 604. The sending unit 604 is configured to send a first PRACH transmission to a network device according to a first PRACH dedicated resource. The first PRACH transmission is used to report the beam failure of the first TRP to the network device. And/or, the sending unit 604 is configured to send a second MAC CE to the network device, the second MAC CE being used to report the beam failure of the second TRP to the network device.

In some implementation, the first MAC CE may include at least one of: first information used for determining a serving cell index for a cell where beam failure is detected; second information used for determining an index of the first TRP where beam failure is detected; third information used for indicating whether a candidate RS ID is included in the first MAC CE; or fourth information that is a candidate RS ID.

In some implementation, the second MAC CE may include at least one of: first information used for determining a serving cell index for a cell where beam failure is detected; second information used for determining an index of the second TRP where beam failure is detected; third information used for indicating whether a candidate RS ID is included in the second MAC CE; or fourth information that is a candidate RS ID.

In some implementation, the first information is a first bitmap, the first bitmap includes a plurality of bits, each of the plurality of bits corresponds to a service cell index, and a value of each bit indicates whether the beam failure is detected in a cell indicated by the service cell index corresponding to the bit.

In some implementation, the second information is a value of a CORESET pool index coresetPoolIndex, and coresetPoolIndex is an index of a CORESET associated with a PDCCH for a TRP where the beam failure is detected.

In some implementation, the first PRACH dedicated resource is a PRACH dedicated resource used for the first TRP to perform the beam failure recovery.

In some implementation, the second PRACH dedicated resource is a PRACH dedicated resource used for the second TRP to perform the beam failure recovery.

In some implementation, the device may include a monitoring unit. The monitoring unit is configured to monitor a PDCCH in a first search space set within a first window.

The obtaining unit 601 is further configured to obtain first DCI from the monitored PDCCH. The first DCI is scrambled by a C-RNTI or MCS-C-RNTI.

In some implementation, the first search space set is determined according to a recovery search space identity recoverySearchSpaceId.

In some implementation, the first window is determined according to a beam failure recovery configuration.

In some implementation, the first PRACH transmission or the second PRACH transmission is in a slot n, and the first window starts from a slot n+k. n and k are positive integers.

In some implementation, the beam failure detection is performed at the granularity of CORESET, and the beam failure corresponding to the beam failure detection is reported at the granularity of CORESET.

In some implementation, the obtaining unit 601 is configured to obtain a beam failure detection RS for each CORESET in a first CORESET pool and the processing unit 602 is configured to perform, according to the beam failure detection RS for each CORESET, beam failure detection for the CORESET. The first CORESET pool is a CORESET pool associated with a PDCCH of the first TRP. The obtaining unit 601 is configured to obtain a beam failure detection RS for each CORESET in a second CORESET pool and the processing unit 602 is configured to perform, according to the beam failure detection RS for each CORESET, beam failure detection for the CORESET. The second CORESET pool is a CORESET pool associated with a PDCCH of the second TRP.

In some implementation, the device may include a sending unit 604. The sending unit 604 is configured to report beam failure for one or more CORESETs to the network device when the beam failure for one or more CORESETs is detected.

In some implementation, the sending unit 604 is configured to report the beam failure for one or more CORESETs to the network device through a MAC CE or UCI.

It is to be understood that in the embodiments of the disclosure, the description on the device for beam failure recovery may be understood with reference to the above related description on the method for beam failure recovery.

FIG. 7 is a schematic structure diagram of a communication device 700 according to an embodiment of the disclosure. The communication device may be a UE, and may also be a network device. The communication device 700 illustrated in FIG. 7 includes a processor 710, and the processor 710 may call and run a computer program in a memory to implement the method in the embodiments of the disclosure.

In one example, as illustrated in FIG. 7, the communication device 700 may further include a memory 720. The processor 710 may call and run the computer program in the memory 720 to implement the method in the embodiments of the disclosure.

The memory 720 may be a separate device independent of the processor 710 and may also be integrated into the processor 710.

In one example, as illustrated in FIG. 7, the communication device 700 may further include a transceiver 730. The processor 710 may control the transceiver 730 to communicate with other devices, specifically, to send information or data to the other device or receiving information or data sent by the other device.

The transceiver 730 may include a transmitter and a receiver. The transceiver 730 may further include an antenna(s), the number of which may be one or more.

In one example, the communication device 700 may specifically be the network device of the embodiments of the disclosure, and the communication device 700 may implement corresponding flows implemented by the network device in each method of the embodiments of the disclosure, which will not be elaborated herein for simplicity.

In one example, the communication device 700 may specifically be the mobile terminal/UE of the embodiments of the disclosure, and the communication device 700 may implement corresponding flows implemented by the mobile terminal/UE in each method of the embodiments of the disclosure, which will not be elaborated herein for simplicity.

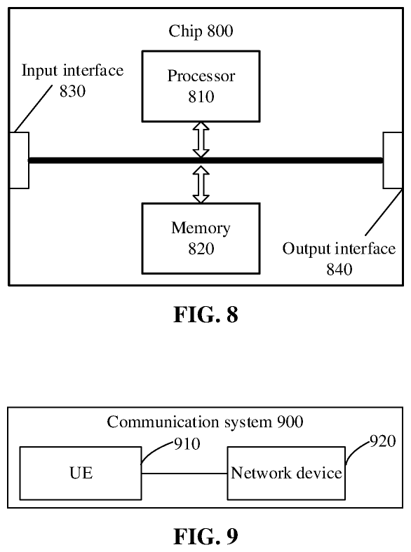

FIG. 8 is a schematic structure diagram of a chip according to an embodiment of the disclosure. The chip 800 illustrated in FIG. 8 includes a processor 810. The processor 810 may call and run a computer program in a memory to implement the method in the embodiments of the disclosure.

In one example, as illustrated in FIG. 8, the chip 800 may further include a memory 820. The processor 810 may call and run a computer program in the memory 820 to implement the method in the embodiments of the disclosure.

The memory 820 may be a separate device independent of the processor 810 and may also be integrated into the processor 810.

In one example, the chip 800 may further include an input interface 830. The processor 810 may control the input interface 830 to communicate with the other device or chip, specifically to acquire information or data from the other device or chip.

In one example, the chip 800 may further include an output interface 840. The processor 810 may control the output interface 840 to communicate with the other device or chip, specifically to output information or data to the other device or chip.

In one example, the chip may be applied to the network device of the embodiments of the disclosure, and the chip may implement corresponding flows implemented by the network device in each method of the embodiments of the disclosure, which will not be elaborated herein for simplicity.

In one example, the chip may be applied to the mobile terminal/UE of the embodiments of the disclosure, and the chip may implement corresponding flows implemented by the mobile terminal/UE in each method of the embodiment of the disclosure, which will not be elaborated herein for simplicity.

It is to be understood that in the embodiments of the disclosure, the chip may also be referred to as a system level chip, a system chip, a chip system or an on-chip system chip.

FIG. 9 is a schematic block diagram of a communication system 900 according to an embodiment of the disclosure. As illustrated in FIG. 9, the communication system 900 includes a UE 910 and a network device 920.

The UE 910 may be configured to realize corresponding functions realized by the UE in the above method, and the network device 920 may be configured to realize corresponding functions realized by the network device in the above method. For simplicity, it will not be elaborated herein.

It is to be understood that the processor in the embodiment of the disclosure may be an integrated circuit chip and has a signal processing capacity. In an implementation process, each operation of the method embodiments may be completed by an integrated logical circuit of hardware in the processor or an instruction in a software form. The processor may be a universal processor, a Digital Signal Processor (DSP), an Application Specific Integrated Circuit (ASIC), a Field Programmable Gate Array (FPGA) or another Programmable Logic Device (PLD), a discrete gate or transistor logic device, and a discrete hardware component. Each method, operation and logical block diagram disclosed in the embodiments of the disclosure may be implemented or executed. The universal processor may be a microprocessor, or the processor may also be any conventional processor, etc. The operations of the method disclosed in combination with the embodiments of the disclosure may be directly embodied to be executed and completed by a hardware decoding processor or executed and completed by a combination of hardware and software modules in the decoding processor. The software module may be in a mature storage medium in this field such as a Random Access Memory (RAM), a flash memory, a Read-Only Memory (ROM), a Programmable ROM (PROM) or Electrically Erasable PROM (EEPROM), and a register. The storage medium is in a memory, and the processor reads information in the memory and completes the operations of the method in combination with hardware.

It may be understood that the memory in the embodiment of the disclosure may be a volatile memory or a non-volatile memory, or may include both the volatile and non-volatile memories. The non-volatile memory may be a ROM, a PROM, an Erasable PROM (EPROM), an EEPROM, or a flash memory. The volatile memory may be a RAM and is used as an external high-speed cache. It is exemplarily but unlimitedly described that RAMs in various forms may be adopted, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It is to be noted that the memory of a system and method described in the disclosure is intended to include, but not limited to, memories of these and any other proper types.

It is to be understood that the above memory is exemplarily but unlimitedly described. For example, the memory in the embodiments of the disclosure may also be an SRAM, a DRAM, an SDRAM, a DDR SDRAM, an ESDRAM, an SLDRAM, and a DR RAM. That is, the memory in the embodiments of the disclosure is intended to include, but not limited to, memories of these and any other proper types.

The embodiments of the disclosure also provide a computer-readable storage medium, which is configured to store a computer program.

In one example, the computer-readable storage medium may be applied to a network device in the embodiments of the disclosure, and the computer program enables a computer to execute corresponding flows implemented by the network device in each method of the embodiments of the disclosure. For simplicity, it will not be elaborated herein.

In one example, the computer-readable storage medium may be applied to a mobile terminal/UE in the embodiments of the disclosure, and the computer program enables a computer to execute corresponding flows implemented by the mobile terminal/UE in each method of the embodiments of the disclosure. For simplicity, it will not be elaborated herein.

The embodiments of the disclosure also provide a computer program product, which includes a computer program instruction.

In one example, the computer program product may be applied to a network device in the embodiments of the disclosure, and the computer program instruction enables a computer to execute corresponding flows implemented by the network device in each method of the embodiments of the disclosure. For simplicity, it will not be elaborated herein.

In one example, the computer program product may be applied to a mobile terminal/UE in the embodiments of the disclosure, and the computer program instruction enables a computer to execute corresponding flows implemented by the mobile terminal/UE in each method of the embodiments of the disclosure. For simplicity, it will not be elaborated herein.

The embodiments of the disclosure also provide a computer program.

In one example, the computer program may be applied to a network device in the embodiments of the disclosure, and the computer program runs in a computer to enable the computer to execute corresponding flows implemented by the network device in each method of the embodiments of the disclosure. For simplicity, it will not be elaborated herein.

In one example, the computer program may be applied to a mobile terminal/UE in the embodiments of the disclosure, and the computer program runs in a computer to enable the computer to execute corresponding flows implemented by the mobile terminal/UE in each method of the embodiments of the disclosure. For simplicity, it will not be elaborated herein.

Those of ordinary skill in the art may realize that the units and algorithm steps of each example described in combination with the embodiments disclosed in the disclosure may be implemented by electronic hardware or a combination of computer software and the electronic hardware. Whether these functions are executed by hardware or software depends on specific applications and design constraints of the technical solutions. Professionals may realize the described functions for each specific application by use of different methods, but such realization shall fall within the scope of the disclosure.

Those skilled in the art may clearly learn about that specific working processes of the system, device and unit described above may refer to the corresponding processes in the method embodiments and will not be elaborated herein for convenient and brief description.

In some embodiments provided in the disclosure, it is to be understood that the disclosed system, device and method may be implemented in another manner. For example, the device embodiments described above are only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between displayed or discussed components may be indirect coupling or communication connection, implemented through some interfaces, of the apparatus or the units, and may be electrical and mechanical or adopt other forms.

The units described as separate parts may or may not be physically separated, and parts displayed as units may or may not be physical units, and namely may be in the same place, or may also be distributed to multiple network units. Part or all of the units may be selected to achieve the purposes of the solutions of the embodiments according to a practical requirement.

In addition, each function unit in each embodiment of the disclosure may be integrated into a processing unit, each unit may also physically exist independently, and two or more than two units may also be integrated into a unit.

When realized in form of software function unit and sold or used as an independent product, the function may also be stored in a computer-readable storage medium. Based on such an understanding, the technical solutions of the disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device or the like) to execute all or part of the operations of the method in each embodiment of the disclosure. The above storage medium includes various media capable of storing program codes such as a U disk, a mobile hard disk, a ROM, a RAM, a magnetic disk, or an optical disk.

The above is only the specific implementation mode of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A method for beam failure recovery, comprising:
obtaining, by a user equipment (UE), a first set of beam failure detection reference signals (RSs) and a second set of beam failure detection RSs, wherein the first set of beam failure detection RSs is a source of quasi-co-location (QCL) assumption for a physical downlink control channel (PDCCH) associated with a first transmission/reception point (TRP), and the second set of beam failure detection RSs is a source of QCL assumption for a PDCCH associated with a second TRP; and
performing, by the UE, beam failure detection and beam failure recovery for the first TRP according to the first set of beam failure detection RSs and performing beam failure detection and beam failure recovery for the second TRP according to the second set of beam failure detection RSs.

2. The method of claim 1, wherein obtaining, by the UE, the first set of beam failure detection RSs and the second set of beam failure detection RSs comprises:
receiving, by the UE, first configuration information and second configuration information, wherein the first configuration information is used to determine the first set of beam failure detection RSs, and the second configuration information is used to determine the second set of beam failure detection RSs; and
obtaining, by the UE, the first set of beam failure detection RSs according to the first configuration information and obtaining the second set of beam failure detection RSs according to the second configuration information.

3. The method of claim 1 or 2, wherein performing, by the UE, beam failure detection and beam failure recovery for the first TRP according to the first set of beam failure detection RSs and performing beam failure detection and beam failure recovery for the second TRP according to the second set of beam failure detection RSs comprises:
generating, by the UE, a first beam failure instance indication from a measurement result of the first set of beam failure detection RSs, and determining that beam failure of the first TRP happens when a number of consecutive first beam failure instance indications reaches a first threshold; and
generating, by the UE, a second beam failure instance indication from a measurement result of the second set of beam failure detection RSs, and determining that beam failure of the second TRP happens when a number of consecutive second beam failure instance indications reaches a second threshold.

4. The method of claim 3, wherein:
generating, by the UE, the first beam failure instance indication from the measurement result of the first set of beam failure detection RSs comprises:
measuring, by a physical layer in the UE, radio link quality of the first set of beam failure detection RSs, and reporting the first beam failure instance indication to a higher layer when the radio link quality of the first set of beam failure detection RSs is less than a third threshold; and
generating, by the UE, the second beam failure instance indication from the measurement result of the second set of beam failure detection RSs comprises:
measuring, by the physical layer in the UE, radio link quality of the second set of beam failure detection RSs, and reporting the second beam failure instance indication to a higher layer when the radio link quality of the second set of beam failure detection RSs is less than a fourth threshold.

5. The method of any one of claims 1-4, further comprising:
receiving, by the UE, third configuration information and fourth configuration information, wherein the third configuration information is used to determine a third set of candidate beam RSs for the beam failure recovery of the first TRP, and the fourth configuration information is used to determine a fourth set of candidate beam RSs for the beam failure recovery of the second TRP.

6. The method of claim 5, further comprising at least one of the following:
when beam failure for the first TRP is detected, selecting, by the UE, a first RS in the third set of candidate beam RSs for the beam failure recovery of the first TRP, wherein radio link quality of the first RS is larger than or equal to a third threshold; or
when beam failure for the second TRP is detected, selecting, by the UE, a second RS in the fourth set of candidate beam RSs for the beam failure recovery of the second TRP, wherein radio link quality of the second RS is larger than or equal to a fourth threshold.

7. The method of any one of claims 1-6, further comprising:
sending, by the UE to a network device, at least one of a first Media Access Control Control Element (MAC CE) or a second MAC CE, wherein the first MAC CE is used to report the beam failure of the first TRP to the network device, and the second MAC CE is used to report the beam failure of the second TRP to the network device.

8. The method of any one of claims 1-6, further comprising:
sending, by the UE to a network device, at least one of a first Physical Random Access Channel (PRACH) transmission according to a first PRACH dedicated resource or a second PRACH transmission according to a second PRACH dedicated resource, wherein the first PRACH transmission is used to report the beam failure of the first TRP to the network device, and the second PRACH transmission is used to report the beam failure of the second TRP to the network device.

9. The method of any one of claims 1-6, further comprising at least one of the following:
sending, by the UE to a network device, a first PRACH transmission according to a first PRACH dedicated resource, wherein the first PRACH transmission is used to report the beam failure of the first TRP to the network device; or
sending, by the UE to the network device, a second MAC CE, wherein the second MAC CE is used to report the beam failure of the second TRP to the network device.

10. The method of claim 7, wherein the first MAC CE comprises at least one of:
first information used for determining a serving cell index for a cell where beam failure is detected;
second information used for determining an index of the first TRP where beam failure is detected;
third information used for indicating whether a candidate reference signal identity (RS ID) is included in the first MAC CE; or
fourth information, wherein the fourth information is a candidate RS ID.

11. The method of claim 7 or 9, wherein the second MAC CE comprises at least one of:
first information used for determining a serving cell index for a cell where beam failure is detected;
second information used for determining an index of the second TRP where beam failure is detected;
third information used for indicating whether a candidate RS ID is included in the second MAC CE; or
fourth information, wherein the fourth information is a candidate RS ID.

12. The method of claim 10 or 11, wherein the first information is a first bitmap, the first bitmap comprises a plurality of bits, each of the plurality of bits corresponds to a service cell index, and a value of each bit indicates whether the beam failure is detected in a cell indicated by the service cell index corresponding to the bit.

13. The method of claim 10 or 11, wherein the second information is a value of a control resource set (CORESET) pool index coresetPoolIndex, and coresetPoolIndex is an index of a CORESET associated with a PDCCH for a TRP where the beam failure is detected.

14. The method of claim 8 or 9, wherein the first PRACH dedicated resource is a PRACH dedicated resource used for the first TRP to perform the beam failure recovery.

15. The method of claim 8, wherein the second PRACH dedicated resource is a PRACH dedicated resource used for the second TRP to perform the beam failure recovery.

16. The method of claim 8 or 9, wherein after sending, by the UE, at least one of the first PRACH transmission or the second PRACH transmission, further comprising:
monitoring, by the UE, a PDCCH in a first search space set within a first window; and
obtaining, by the UE, first downlink control information (DCI) from the monitored PDCCH, the first DCI being scrambled by a cell radio network temporary identity (C-RNTI) or modulation and coding scheme (MCS)-C-RNTI.

17. The method of claim 16, wherein the first search space set is determined according to a recovery search space identity recoverySearchSpaceId.

18. The method of claim 16 or 17, wherein the first window is determined according to a beam failure recovery configuration.

19. The method of any one of claims 16-18, wherein the first PRACH transmission or the second PRACH transmission is in a slot n, and the first window starts from a slot n+k, n and k being positive integers.

20. The method of any one of claims 1-19, wherein the beam failure detection is performed at a granularity of CORESET, and the beam failure corresponding to the beam failure detection is reported at the granularity of CORESET.

21. The method of claim 20, further comprising at least one of the following:
obtaining, by the UE, a beam failure detection RS for each CORESET in a first CORESET pool and performing, according to the beam failure detection RS for each CORESET, beam failure detection for the CORESET, wherein the first CORESET pool is a CORESET pool associated with a PDCCH of the first TRP; or
obtaining, by the UE, a beam failure detection RS for each CORESET in a second CORESET pool and performing, according to the beam failure detection RS for each CORESET, beam failure detection for the CORESET, wherein the second CORESET pool is a CORESET pool associated with a PDCCH of the second TRP.

22. The method of claim 20 or 21, further comprising:
detecting, by the UE, beam failure for one or more CORESETs and reporting the beam failure for one or more CORESETs to the network device.

23. The method of claim 22, wherein reporting the beam failure for one or more CORESETs to the network device comprises:
reporting, by the UE to the network device, the beam failure for one or more CORESETs through a MAC CE or uplink control information (UCI).

24. A device for beam failure recovery, applied to a user equipment (UE) and comprising:
an obtaining unit, configured to obtain a first set of beam failure detection reference signals (RSs) and a second set of beam failure detection RSs, wherein the first set of beam failure detection RSs is a source of quasi-co-location (QCL) assumption for a physical downlink control channel (PDCCH) associated with a first transmission/reception point (TRP), and the second set of beam failure detection RSs is a source of QCL assumption for a PDCCH associated with a second TRP; and
a processing unit, configured to perform beam failure detection and beam failure recovery for the first TRP according to the first set of beam failure detection RSs and perform beam failure detection and beam failure recovery for the second TRP according to the second set of beam failure detection RSs.

25. The device of claim 24, further comprising:
a receiving unit, configured to receive first configuration information and second configuration information, wherein the first configuration information is used to determine the first set of beam failure detection RSs, and the second configuration information is used to determine the second set of beam failure detection RSs;
wherein the obtaining unit is configured to obtain the first set of beam failure detection RSs according to the first configuration information and obtain the second set of beam failure detection RSs according to the second configuration information.

26. The device of claim 24 or 25, wherein the processing unit is configured to:
generate a first beam failure instance indication from a measurement result of the first set of beam failure detection RSs, and determine that beam failure of the first TRP happens when a number of consecutive first beam failure instance indications reaches a first threshold; and
generate a second beam failure instance indication from a measurement result of the second set of beam failure detection RSs, and determine that beam failure of the second TRP happens when a number of consecutive second beam failure instance indications reaches a second threshold.

27. The device of claim 26, wherein the processing unit is configured to control a physical layer in the UE to:
measure radio link quality of the first set of beam failure detection RSs, and report the first beam failure instance indication to a higher layer when the radio link quality of the first set of beam failure detection RSs is less than a third threshold; and
measure radio link quality of the second set of beam failure detection RSs, and report the second beam failure instance indication to a higher layer when the radio link quality of the second set of beam failure detection RSs is less than a fourth threshold.

28. The device of any one of claims 24-27, further comprising:
a receiving unit, configured to receive third configuration information and fourth configuration information, wherein the third configuration information is used to determine a third set of candidate beam RSs for the beam failure recovery of the first TRP, and the fourth configuration information is used to determine a fourth set of candidate beam RSs for the beam failure recovery of the second TRP.

29. The device of claim 28, wherein the processing unit is configured to perform at least one of the following:
when beam failure for the first TRP is detected, selecting a first RS in the third set of candidate beam RSs for the beam failure recovery of the first TRP, wherein radio link quality of the first RS is larger than or equal to a third threshold; or
when beam failure for the second TRP is detected, selecting a second RS in the fourth set of candidate beam RSs for the beam failure recovery of the second TRP, wherein radio link quality of the second RS is larger than or equal to a fourth threshold.

30. The device of any one of claims 24-29, further comprising:
a sending unit, configured to send at least one of a first Media Access Control Control Element (MAC CE) or a second MAC CE to a network device, wherein the first MAC CE is used to report the beam failure of the first TRP to the network device, and the second MAC CE is used to report the beam failure of the second TRP to the network device.

31. The device of any one of claims 24-29, further comprising:
a sending unit, configured to send at least one of a first Physical Random Access Channel (PRACH) transmission to a network device according to a first PRACH dedicated resource or a second PRACH transmission to the network device according to a second PRACH dedicated resource, wherein the first PRACH transmission is used to report the beam failure of the first TRP to the network device, and the second PRACH transmission is used to report the beam failure of the second TRP to the network device.

32. The device of any one of claims 24-29, further comprising a sending unit, wherein the sending unit is configured to perform at least one of the following:
sending a first PRACH transmission to a network device according to a first PRACH dedicated resource, wherein the first PRACH transmission is used to report the beam failure of the first TRP to the network device; or
sending a second MAC CE to the network device, wherein the second MAC CE is used to report the beam failure of the second TRP to the network device.

33. The device of claim 30, wherein the first MAC CE comprises at least one of:
first information used for determining a serving cell index for a cell where beam failure is detected;
second information used for determining an index of the first TRP where beam failure is detected;
third information used for indicating whether a candidate reference signal identity (RS ID) is included in the first MAC CE; or
fourth information, wherein the fourth information is a candidate RS ID.

34. The device of claim 30 or 32, wherein the second MAC CE comprises at least one of:
first information used for determining a serving cell index for a cell where beam failure is detected;
second information used for determining an index of the second TRP where beam failure is detected;
third information used for indicating whether a candidate RS ID is included in the second MAC CE; or
fourth information, wherein the fourth information is a candidate RS ID.

35. The device of claim 33 or 34, wherein the first information is a first bitmap, the first bitmap comprises a plurality of bits, each of the plurality of bits corresponds to a service cell index, and a value of each bit indicates whether the beam failure is detected in a cell indicated by the service cell index corresponding to the bit.

36. The device of claim 33 or 34, wherein the second information is a value of a control resource set (CORESET) pool index coresetPoolIndex, and coresetPoolIndex is an index of a CORESET associated with a PDCCH for a TRP where the beam failure is detected.

37. The device of claim 31 or 32, wherein the first PRACH dedicated resource is a PRACH dedicated resource used for the first TRP to perform the beam failure recovery.

38. The device of claim 31, wherein the second PRACH dedicated resource is a PRACH dedicated resource used for the second TRP to perform the beam failure recovery.

39. The device of claim 31 or 32, further comprising:
a monitoring unit, configured to monitor a PDCCH in a first search space set within a first window;
wherein the obtaining unit is configured to obtain first downlink control information (DCI) from the monitored PDCCH, the first DCI being scrambled by a cell radio network temporary identity (C-RNTI) or modulation and coding scheme (MCS)-C-RNTI.

40. The device of claim 39, wherein the first search space set is determined according to a recovery search space identity recoverySearchSpaceId.

41. The device of claim 39 or 40, wherein the first window is determined according to a beam failure recovery configuration.

42. The device of any one of claims 39-41, wherein the first PRACH transmission or the second PRACH transmission is in a slot n, and the first window starts from a slot n+k, n and k being positive integers.

43. The device of any one of claims 24-42, wherein the beam failure detection is performed at a granularity of CORESET, and the beam failure corresponding to the beam failure detection is reported at the granularity of CORESET.

44. The device of claim 43, wherein:
the obtaining unit is configured to obtain a beam failure detection RS for each CORESET in a first CORESET pool and the processing unit is configured to perform, according to the beam failure detection RS for each CORESET, beam failure detection for the CORESET, wherein the first CORESET pool is a CORESET pool associated with a PDCCH of the first TRP; or
the obtaining unit is configured to obtain a beam failure detection RS for each CORESET in a second CORESET pool and the processing unit is configured to perform, according to the beam failure detection RS for each CORESET, beam failure detection for the CORESET, wherein the second CORESET pool is a CORESET pool associated with a PDCCH of the second TRP.

45. The device of claim 43 or 44, further comprising:
a sending unit, configured to report beam failure for one or more CORESETs to the network device when the beam failure for one or more CORESETs is detected.

46. The device of claim 45, wherein the sending unit is configured to:
report the beam failure for one or more CORESETs to the network device through a MAC CE or uplink control information (UCI).

47. A user equipment (UE), comprising a processor and a memory, wherein the memory is configured to store a computer program, and the processor is configured to call and run the computer program stored in the memory to execute the method of any one of claims 1-23.

48. A chip, comprising a processor, configured to call and run a computer program in a memory to enable a device installed with the chip to execute the method of any one of claims 1-23.

49. A computer-readable storage medium, configured to store a computer program that enables a computer to execute the method of any one of claims 1-23.

50. A computer program product, comprising a computer program instruction that enables a computer to execute the methods of any one of claims 1-23.

51. A computer program, enabling a computer to execute the method of any one of claims 1-23.
